(19) United States
(12) Patent Application Publication
(10) Pub. No.: US 2007/0220742 A1
(43) Pub. Date: Sep. 27, 2007

(54) METHOD FOR FABRICATING IDENTIFICATION CODE

(75) Inventors: Kuang-Lin Lo, Kaohsiung County (TW); Yung-Hui Wang, Kaohsiung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ADVANCED SEMICONDUCTOR ENGINEERING, INC., Kaohsiung (TW)

(21) Appl. No.: 11/467,568

(22) Filed: Aug. 28, 2006

(30) Foreign Application Priority Data
Mar. 24, 2006 (TW) 95110225

(51) Int. Cl. H01R 43/00; G08B 13/14; G06K 7/00

(52) U.S. Cl. 29/825; 340/572.8; 235/439

(57) ABSTRACT

A method for fabricating an identification code is provided. First, a metallic film is provided for fabricating a circuit on a substrate, and a circuit area and a non-circuit area are formed on the metallic film after a patterning process. Next, an identification code is formed on the non-circuit area for the basis of production management and quality control.

### CROSS-REFERENCE TO RELATED APPLICATION

This application claims the priority benefit of Taiwan application serial no. 95110225, filed Mar. 24, 2006. All disclosure of the Taiwan application is incorporated herein by reference.

### BACKGROUND OF THE INVENTION

1. Field of the Invention

The present invention relates to a substrate, and more particularly, to a method for fabricating an identification code on a substrate.

2. Description of the Related Art

The matrix packaging substrate composed of a plurality of matrix substrates distributed in stripes is one of the most commonly used elements in the modern semiconductor package fabricating process. After the semiconductor device (e.g. a chip) is electrically coupled to a sub-substrate in the matrix substrate, all semiconductor devices on every matrix substrate will be covered by a molding compound, so as to form a matrix type chip package structure. Finally, the sub-substrates of each matrix substrate and its corresponding molding compound are divided to fabricate several hundreds of separate chip package units.

It is to be noted that during the fabricating process of the matrix packaging substrate, one batch number and one check number are respectively provided to all the products fabricated in the same batch, but none of the sub-substrates in the matrix substrate (or the motherboard) is provided with an identification code for identifying the source and manufacturing date of the product. Therefore, after the matrix substrate is divided into a huge number of separate sub-substrates, the reference information for distinguishing each sub-substrate is lost. In such case, only the ID number that has been attached on the chip package product is provided. It is obviously disadvantageous for the production management, quality control and product reliability analysis. Once the circuit on the sub-substrate fails, it is not possible to track the source, i.e. the motherboard, and find out the root cause of the failure.

### SUMMARY OF THE INVENTION

Therefore, it is an object of the present invention to provide a method for fabricating an identification code, such that the identification code that can identify the source and the regarding information is formed on the substrate to improve the effectiveness of production management and quality control.

It is another object of the present invention to provide a circuit substrate having an identification code formed thereon. With such identification code, it is possible to track the source, and accordingly to find out the possible root cause for the failure.

The present invention provides a method for fabricating an identification code. The method comprises the following steps. First, a metallic film is provided for fabricating a circuit on a substrate, and a circuit area and a non-circuit area are formed on the metallic film after a patterning process. Next, an identification code is formed on the non-circuit area.

The present invention further provides a circuit substrate having an identification code formed thereon. The circuit substrate comprises a first metallic film, and an identification code. The first metallic film is disposed on a first surface of a substrate and consisted of a circuit area and a non-circuit area. In addition, the identification code is formed on the non-circuit area.

The present invention further provides a method for fabricating an identification code. First, a first metallic film on a first surface of a substrate is provided, then a circuit formed on a first area of the first metallic film is performed and the identification code formed on a second area of the first metallic film is performed.

In accordance with an embodiment of the present invention, after the formation of the identification code, further comprising forming a dielectric layers on the substrate to cover the circuit area and the non-circuit area, wherein the substrate is a core layer of a matrix substrate.

In accordance with an embodiment of the present invention, the identification code is formed on the non-circuit area by laser drilling process, and the identification code includes patterns or numerical figures such as the barcode or serial number which can be recognized by the computer system.

The substrate provided by the present invention has an identification code with different serial numbers or related information. The identification code is formed on the non-circuit area of the substrate for identifying each other. Therefore, after the matrix substrate (or the motherboard) has been divided into a plurality of sub-substrates, it is still possible to identify its source based on the identification code formed on the substrate, such that the effectiveness of production management and quality control is improved.

### BRIEF DESCRIPTION DRAWINGS

The accompanying drawings are included to provide a further understanding of the invention, and are incorporated in and constitute a portion of this specification. The drawings illustrate embodiments of the invention, and together with the description, serve to explain the principles of the invention.

FIGS. 1˜3 schematically show a process for forming an identification code on a metallic film.

FIGS. 3A˜3C schematically show three different types of identification codes.

FIG. 4 schematically shows a circuit substrate having an identification code formed thereon.

### DESCRIPTION PREFERRED EMBODIMENTS

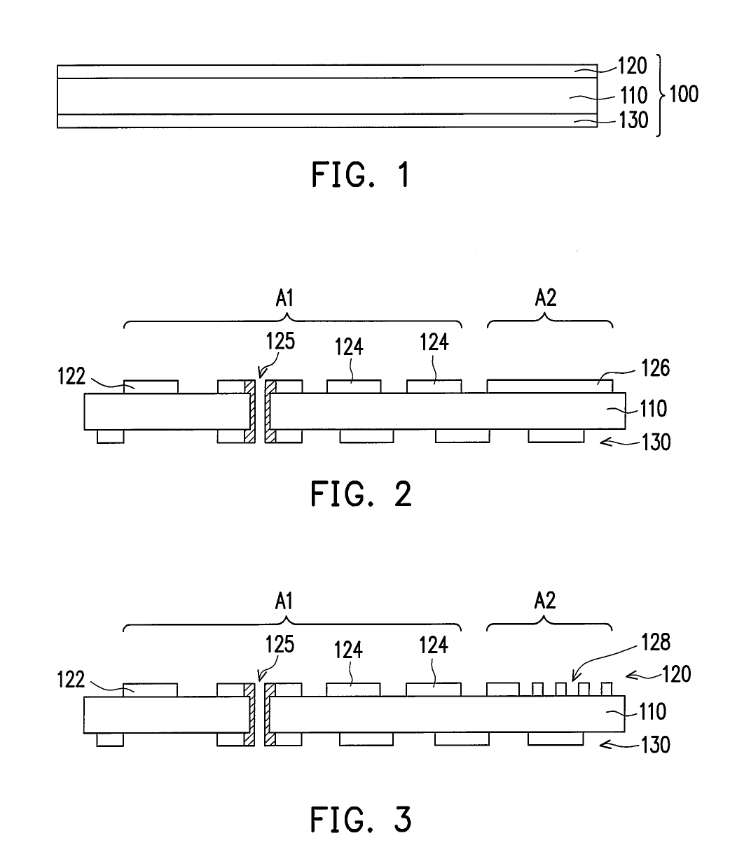

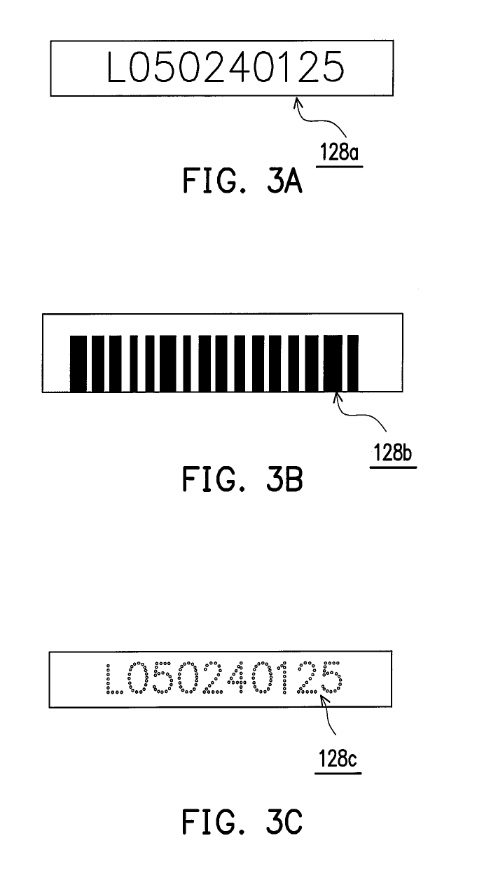

FIGS. 1˜3 schematically show a process for forming an identification code on a metallic film. Referring to FIG. 1, first a multi-layer structure 100 is provided. The multi-layer structure 100 has two metallic films 120 and 130 that are laminated on two opposite surfaces of a core layer 110, wherein the core layer 110 is provided as a substrate, and the metallic films 120 and 130 are formed on the core layer 110. These two metallic films 120 and 130 may be copper films or copper electroplated layers, or other metals. The metallic films 120 and 130 are formed as a circuit 122 and a bond pad 124 by well-known patterning circuit techniques such as exposure, developing, and etching. Since these techniques are well known by one of the ordinary skills in the art, the detailed description of photo resist, developer, etching liquid, and detergent used in the patterning process are omitted herein. In the present embodiment, in addition to forming a circuit with a predetermined pattern on a first area A1 of the metallic film 120, a second area 126 (it is referred to as a non-circuit area A2 hereinafter) that is not patterned is also reserved on the metallic film 120 for forming the identification code 128 as shown in FIG. 3. Of course, the circuit area A1 of FIG. 2 also can be fabricated after the formation of the identification code 128 on the non-circuit area A2, in other words, the implementation is not impacted by the sequence of the figure numbers.

In FIG. 2, the metallic film 120 comprises a circuit area A1 and a non-circuit area A2, wherein the circuit area A1 comprises a circuit transmission structure including all of the circuits 122, a bond pad 124, and a conductive through hole 125. The non-circuit area A2 is a complete flat surface, such that the desired patterns and numerical figures can be formed on the complete flat surface so as to fabricate the serial number code 128a as shown in FIG. 3A or the barcode 128b as shown in FIG. 3B. The encoded content of the ID number code 128a or the barcode 128b may include product batch number, check number, ID number of the motherboard, and the fabricating process related information. In addition, the encoded content of the serial number code 128a or barcode 128b may be arranged in a way so that the production management and quality control can be easily managed in consideration of the real requirement. FIG. 3C schematically shows another embodiment of the present invention, in which a laser beam is emitted onto the non-circuit area A2 with a non-continuous etching process, such that a plurality of numerical figures or texts for identification are hollowed to finally form an identification code 128c.

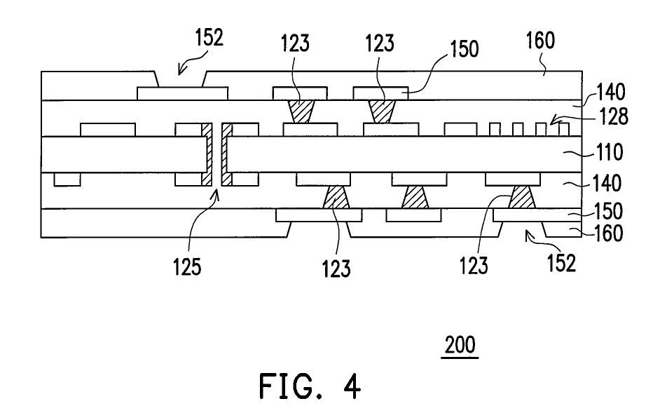

Referring to FIG. 4, after the formation of the circuit of FIG. 2 and the identification code of FIG. 3 is completed, a dielectric layer 140, a surface metallic layer 150, and a solder mask layer 160 are sequentially formed on the core layer 110 and its metallic film, such that the metallic films 120 and 130 are disposed between two adjacent dielectric layers 110 and 140, and the metallic films 120 and 130 are connected to a contact 152 of the surface metallic layer 150 via an conductive via hole 123 or a conductive through hole 125 to transmit signals to the outside. In the present embodiment, although the identification code 128 is formed on the metallic film 120 above the core layer 110 (also known as a core dielectric layer), the identification code 128 may be alternatively formed on the surface metallic layer 150 or another metallic layer, and its implementation is not limited by this. In addition, the identification code 128 may be hidden below the solder mask layer 160 of the circuit substrate 200. In such case, when an X-ray with perspective vision capability is emitted thereon, the identification code 128 is clearly recognized, so as to further obtain the related information of the circuit substrate 200. Accordingly, in cooperation with the modern techniques, the physical attachment of the serial number on the surface of the chip package product used in the current fabricating process is replaced with the hidden identification code 128. In such case, the hidden identification code 128 is hard to find, thus its security level is further improved. Additionally, after the matrix substrate (or the motherboard) has been divided into a plurality of sub-substrates, it is still possible to identify its source based on the identification code 128 formed on the circuit substrate 200. Accordingly, in case the circuit on the substrate fails, the source of the substrate, i.e. the motherboard, can be tracked according to the identification code to find out the possible root cause of the failure as well as the batch number, such that the production quality is further improved.

Although the invention has been described with reference to a particular embodiment thereof, it will be apparent to one of the ordinary skills in the art that modifications to the described embodiment may be made without departing from the spirit of the invention. Accordingly, the scope of the invention will be defined by the attached claims not by the above detailed description.

What is claimed is:

1. A method for fabricating an identification code, comprising:
providing a metallic film for fabricating a circuit on a substrate, and performing a patterning process on the metallic film to form a circuit area and a non-circuit area; and
forming the identification code on the non-circuit area.

2. The method for fabricating the identification code of claim 1, after the formation of the identification code, further comprising forming a dielectric layers on the substrate to cover the circuit area and the non-circuit area.

3. The method for fabricating the identification code of claim 2, wherein the substrate is a core layer of a matrix substrate.

4. The method for fabricating the identification code of claim 1, wherein the step for forming the identification code on the non-circuit area is performed by using laser drilling process.

5. The method for fabricating the identification code of claim 1, wherein the identification code comprises a barcode or a serial number code.

6. A method for fabricating an identification code, comprising:
providing a first metallic film on a first surface of a substrate;
forming a circuit on a first area of the first metallic film; and
forming the identification code on a second area of the first metallic film.

7. The method for fabricating the identification code of claim 6, further comprising providing a second metallic film on a second surface of the substrate, wherein the first and the second surface of the substrate are opposite.

8. The method for fabricating the identification code of claim 7, wherein the second metallic film further comprises a circuit.

9. The method for fabricating the identification code of claim 6, further comprising forming a dielectric layer to cover the circuit and the identification code.

10. The method for fabricating the identification code of claim 6, wherein the substrate is a core layer of a matrix substrate.

11. The method for fabricating the identification code of claim 6, wherein the step for forming the identification code on the non-circuit area is performed by using a laser drilling process.

12. The method for fabricating the identification code of claim 6, wherein the identification code comprises a barcode or a serial number code.
